(19) United States
(12) Patent Application Publication
(10) Pub. No.: US 2013/0198204 A1
(43) Pub. Date: Aug. 1, 2013

(54) SYSTEM AND METHOD DETERMINING ONLINE SIGNIFICANCE OF CONTENT ITEMS AND TOPICS USING SOCIAL MEDIA

(71) Applicants: Timothy Peter WILLIAMS, London (GB); Yew Sun Ding, Singapore (SG); Daniel Hobbs, San Francisco, CA (US); Daniel Schmidt, San Francisco, CA (US); Doug Asherman, Oakland, CA (US)

(72) Inventors: Timothy Peter WILLIAMS, London (GB); Yew Sun Ding, Singapore (SG); Daniel Hobbs, San Francisco, CA (US); Daniel Schmidt, San Francisco, CA (US); Doug Asherman, Oakland, CA (US)

(21) Appl. No.: 13/563,667

(22) Filed: Jul. 31, 2012

Related U.S. Application Data
(63) Continuation of application No. 12/950,356, filed on Nov. 19, 2010.

(51) Int. Cl. G06F 17/30

(52) U.S. Cl. CPC G06F 17/30283
USPC 707/748

(57) ABSTRACT

A set of content items is identified that is relevant to a topic. The communications provided with a plurality of social networking mediums are processed to identify individual communications that reference content items from the set. A score is determined for each of the one or more content items. The score of each of the one or more content items can be based at least in part on a number of instances in which that content item is referenced by the communications of the social networking mediums. A presentation can be provided that identifies a plurality of content items, as well as the score for each of the plurality of content items.

### RELATED APPLICATIONS

This application is a continuation-in-part of U.S. patent application Ser. No. 12/950,356, filed Nov. 19, 2010; the aforementioned priority application being hereby incorporated by reference in its entirety.

### TECHNICAL FIELD

Embodiments described herein relate to a system and method for determining online significance of content items and topics using social media.

### BACKGROUND

Social media services are prevalent in a variety of forms. The communications exchanged in social media environments can be analyzed for purpose of determining insight.

### BRIEF DESCRIPTION OF THE DRAWINGS

FIG. 1 illustrates a system for determining a significance of online content items using social media, according to one or more embodiments.

FIG. 2 illustrates a method for determining an online significance of a content item, according to one or more embodiments.

FIG. 3 illustrates a method for processing targeted social media to determine trends amongst topics and content items, according to one or more embodiments.

FIG. 4 illustrates an example presentation for displaying scores and information regarding the online significance of content items, according to one or more examples.

FIG. 5 illustrates an example presentation for graphically displaying scores and other information determined from the social media of targeted sources.

FIG. 6 illustrates another embodiment in which social media is collected from comments submitted in connection with another content item, according to one or more embodiments.

FIG. 7 is a block diagram that illustrates a computer system upon which embodiments described herein may be implemented.

### DETAILED DESCRIPTION

Embodiments described herein include a system and method for determining real-time metrics that quantify an online significance of content items (e.g., new story or video clip). The determined online significance can be correlated to how popular the content item is amongst an online population of viewers, as well as to trends in the viewership of the content items. Further, some embodiments correlate the online significance of the content to trends or newsworthy significance in the underlying topic of the content item.

Among other benefits, embodiments such as described herein provide a mechanism to enable content publishers to identify topics of interest amongst the general public in real-time (i.e., as the public interest is happening). For content providers in particular (e.g., online magazine publisher, etc.), embodiments facilitate the determination as to what topics of interest are currently trending in interest or awareness amongst an online population. The content provider can also determine what topics are likely of significant interest in a next day or time period. Still further, embodiments enable content providers to track content items published by other content providers, as well as topics covered by other publishers. Such tracking can enable content providers to maintain awareness of what content from other providers is trending or of interest to the public.

Still further, some embodiments enable determination of significance or trends amongst topics that correlate to content items. For example, the identification of a trend in the sharing or viewership of a news article can be correlated to a trend in interest for the topic of the news article. As a case example, an article pertaining to a new functional feature of a product can correlate to popularity for the product if the article shows relative high presence with social media in a given time period.

Additionally, some embodiments recognize that social media from select individuals can be highly relevant for determining significance of online content items or topics in a particular field. In particular, the individuals can be selected based on their expertise, influence, or declared interest or knowledge for a particular topic. The social media from such individuals can be aggregated and used to determine significance of topics or content items.

In some embodiments, a set of content items are identified that are relevant to a topic. The communications provided with a plurality of social media services are processed to identify items of social media that reference content items from the set. A score is determined for each of the one or more content items. The score of each of the one or more content items can be based at least in part on a number of instances in which that content item is referenced by the social media of the social media services. A presentation can be provided that identifies a plurality of content items, as well as a score for each of the plurality of content items that indicates the significance of the content item amongst the online public.

As used herein, “significance,” in the context of content items or topics, reflects the number of times that a content item is viewed, discussed and/or shared. In some implementations, the significance can indicate a trend or rise in sharing/viewing.

“Social media services” can refer to services provided by social networking services, such as FACEBOOK, TWITTER, LINKEDIN, REDDIT, DIGG and GOOGLE PLUS, as well as to content sharing sites such as YOUTUBE. In some variations, the “social media services” can also reflect integration of content items originating from persons with published content from publishers. As an example, “social media services” can reflect commentary provided by users in response to articles or video clips. Such commentary can often be made through social networking services such as FACEBOOK. Thus, the significance assigned to a content item or topic can reflect a determination that is relative to other items or topics.

An “item of social media” can refer to communications from individuals in connection with a social media service. As examples, an item of social media can correspond to a post submission, image or video submission, text content to self-post or media submission, text content provided for submissions of other users, comments provided with or in response to content items, ratings, “likes” (or alternative monikers such as “Diggs”), check-ins, and re-postings (e.g., retweets).

Under some embodiments, a set of individuals are identified who are relevant to a particular topic. A set of terms are also identified for the particular topic, where each term can correspond to one of a product identifier, a brand or a corporate entity. Items of social media can be identified that originate from individuals in the set of individuals in one or more social media outlets. The items of social media are processed to determine individual communications that are relevant to at least one term in the set of terms. From the items of social media, one or more terms in the set of terms are determined that are of significance at a particular interval of time (e.g., over the course of a day or series of days, etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Overview

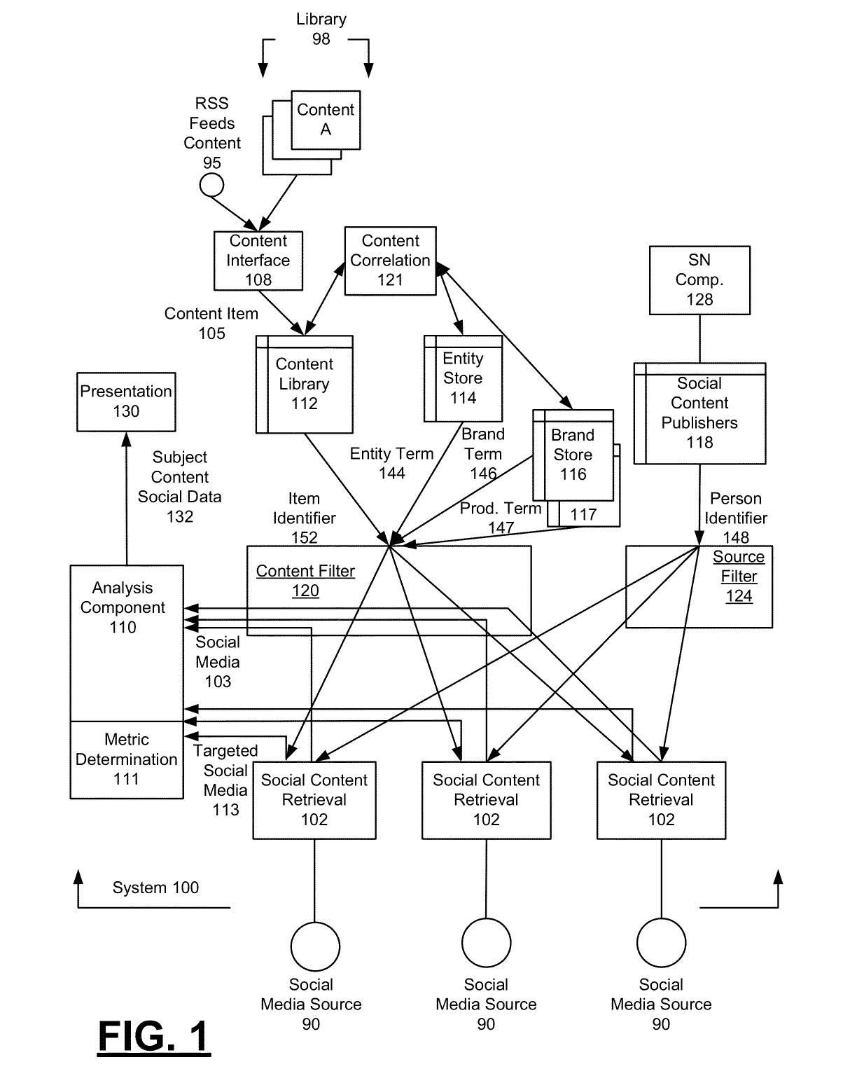

FIG. 1 illustrates a system for determining a significance of online content items using social media, according to one or more embodiments. The system 100 can include components that are implemented as network side resources (e.g., on a server). In variations, select components can be operated on user machines (e.g., machines of customers, including online editors or content providers who wish to see what content items are trending). For example, functionality provided with at least some of the components of system 100 can be implemented on a customer machine, such as in the way of scripts that run on a client browser, or through installation and operation of a client application. In one implementation, system 100 includes a service, operable to communicate with client terminals (e.g., customer terminals that operate web browsers). Accordingly, implementation of system 100 can include use of one or more servers, or other network-side computing environments, such as provided by peer-to-peer networks, etc. In alternative implementations, some or all of the components of system 100 can be implemented on client machines, such as through applications that operate on desktop terminals. For example, a client application may execute to perform the processes described by the various components of system 100.

According to some embodiments, a system 100 includes components that operate to monitor significance of content items published online, such as news articles, blog entries, videos and other content items. In particular, system 100 includes components that operate to analyze social media in order to determine what content items are trending online in popularity, viewership or commentary. Such determinations can be made for a discrete duration of time, such as over the course of an hour, a portion of a day, or a day. Moreover, the determinations can be made in near-real time.

As an addition or alternative, system 100 includes components that operate to identify social media that originates or includes input from individuals who are deemed influential or relevant to a particular topic. The social media of such individuals can be analyzed in order to determine content items and/or topics that are gaining significance in a particular duration of time (e.g., hour, day).

According to some embodiments, system 100 includes one or more social content retrieval components 102, one or more content interfaces 108, an analysis component 110, one or more filters, and a presentation component 130. The social content retrieval components 102 retrieve social media 103 from various sources of social media 90. In some implementations, the social content retrieval components 102 retrieve social media 103 from various sources in bulk, and use a combination of filters to determine when items of social media 103 reference a specific content item or topic, and/or when the social media originates from a particular person. As an addition or alternative, social content retrieval components 102 can target their retrieval of social media to specific sources (e.g., specific posts, feeds or accounts) of social media. Accordingly, system 100 can include filters corresponding to, for example, a content filter 120 and a source filter 124. Other kinds of filters may also be employed. The content filter 120 processes the social media 103 in order to determine items in the social media 103 which pertain to specific topics, as specified by one or more libraries of system 100. The source filter 124 can process the social media 103 to identify specific posters or authors of social media. In addition to content and source filters 120, 124, other kinds of filters may also be used. For example, geographic filters can be used to filter social media based on geographic regions of the sources (e.g., social network users) for social media.

As described in greater detail, system 100 can also utilize libraries that specify information about content items, publishers of social media, business entities, brands or products. The analysis component 110 can process the items of social media 103 to determine information such as content items or topics referenced in the social media 103, as well as metrics for determining the significance of the content items or topics.

In more detail, the social content retrieval components 102 operate to retrieve social media 103 from various social media sources 90. For example, the social content retrieval components 102 can be programmed to retrieve social media 103 from sources such as FACEBOOK, TWITTER, LINKEDIN, and/or YOUTUBE. Embodiments further recognize that social media is increasingly integrated in various online context. For example, websites (e.g., news sites) with content can include social commentary that links to social networking sites or accounts of the user. The social media 103 can include (i) postings (e.g., text content authored from posters), (ii) comments, (iii) non-textual feedbacks such as “Likes” or ratings, (iv) tags, such as provided with pictures, video clips or other postings, and (v) images and/or videos. The social content retrieval components 102 can retrieve social media 103 and identify the source, the authors, and the type of social media. The content filter 120 can be used to filter the social media 103 by topic or for presence of content items 105 (e.g., identifiable through links). The source filters 124 can identify the source of the social media (“targeted social media 113”).

The content interfaces 108 can include, for example, programmatic interfaces, agents and/or retrieval components, to receive or retrieve content items 105 from various sources. The content interfaces 108 can retrieve content items 105 from designated sources 95 and libraries 98, such as Really Simple Syndication (RSS) feeds originating form a particular website (e.g., company site), video clips on a particular online channel, or news articles under a particular heading. The interfaces 108 may store data that includes information for enabling subsequent references to the individual content items. The information can include an identifier of the content items, as well data that reproduces a content portion of the content item, or alternatively provides access to the content items. As examples, the individual content items 105 can correspond to news articles, RSS feeds, video clips, social media items (e.g., a TWEET) or blog entries.

In some embodiments, the system 100 includes a content item library 112, an entity store 114, a brand store 116, a product store 117, and a social content publisher store 118. In variations, other types of commercial items or assets can be identified for use in with embodiments. For example, separate stores can be maintained for streaming content (e.g., movies, songs), or downloadable digital resources.

With regard to content items, the content interface 108 can access specified sources of content items 105 (e.g., RSS feed from a specific website), to retrieve information sufficient for determining when subsequent reference is made in social media 103 to the retrieved content items. In one implementation, the data stored in the content library 112 can include a content item identifier, and data that includes or provides access to the content portion. More specifically, the content library 112 can include or correspond to, for example, an identifier of the content item 105, and one or more of (i) a copy of the content items, (ii) portions of content items, and/or (iii) links to content items.

The social content publisher store 118 can include identifiers (e.g., names, online monikers, login names) of persons (“person identifiers 148”) who are deemed to be influential for a particular topic (e.g., technology). Additionally, the social content publisher store 118 can include identifiers for persons who have associated biography information that indicates they are knowledgeable or interested in a topic. In one implementation, a social network component 128 can utilize biography information, such as, for example, the information individuals provide in describing themselves on social networking sites. For example, information individuals provide regarding their hobbies or interests can be scanned and correlated to a particular topic. The source filter 124 can use identifiers from the social content publisher store 118 to filter acquisition of social media in order to identify targeted social media originating from specific individuals. In variations, input from the social content publisher store 118 can be used to target the social content retrieval components 102.

In some embodiments, a correlation component 121 can be implemented to correlate the content items 105 with topics, such as products (e.g., see product store 117), brands (e.g., see brand store 116) business entities (e.g., see entity store 114) or assets such as streaming or downloadable content. For example, the correlation component 121 can correlate a news article, a social media post, or a video clip to a specific product, brand and/or business entity based on (i) a source of the content item 105 (e.g., website or RSS feed), and/or (ii) the presence of key words or terms within the body of the content item (or its associated metadata or tags) that are indicators for a particular product, brand or entity. In this way, the determinations made about the online significance of content items 105 can then be correlated to particular topics, such as products, brands or corporate entities.

The analysis component 110 operates to scan social media 103 for identifiers (“item identifier 152”) to content items 105 stored in the content library 112. In one implementation, the social media 103 is parsed to identify links to articles. The links can be compared to those maintained for content items 105 in the content library 112 to determine matching content items. In some implementations, the content library 112 can maintain links to versions or copies or articles, and reference the insertion of links into social media against the list to determine whether the links correspond to news articles or other content items.

Still further, social media 103 can be parsed for indicators of content items, such as text that can be matched to a title, byline, author or summary of a news article (as an example of a content item). As another variation, the social media 103 can be inspected for reference to tags or other metadata that can serve as an identifier to an article or other content item of the content library 112.

As an addition or variation, the comments accompanying content items can be extracted for posts. In cases where posts are made through social media identifiers of persons, the comments accompanying content items can be parsed through, for example, the source filter 124 to identify whether influencers or other individuals for a particular topic have made comments on the content item. In some variations, the social media 103 can be parsed or scanned for key words that are indicative of a product, brand or business entity. For example, the social media 103 can be topiced to content filters 120 which incorporate input from the entity store 114, brand store 116, or product store 117.

As another addition or alternative, the analysis component 110 scans the social media 103 to determine feedback (e.g., “likes” or ratings) for the content item in the social networking environment. Still further, in some variations, comments to content items can be processed. For example, the commentary provided with video clips can be extracted and analyzed.

In one embodiment, the analysis component 110 determines one or more scores for individual content items 105 that are referenced in the social media 103. The analysis component 110 also includes a metric determination 111 which can implement, for example, weights or algorithms to determine scores for the content items 105, based on metrics such as (i) the number of references a content item has in the social media 103, (ii) the number of comments posted for a content item or reference to a content item, and/or (iii) the feedback or rating (e.g., “likes”) that content items receive in the social media context. The metric determination 111 may also account for a duration of time over which metrics for content items are determined (e.g., same day or past days).

In addition to tracking content items in social media 103, one or more embodiments track social media from specific persons (“targeted social media 113”). In an embodiment, the targeted social media 113 can be passed through content filters 120, which can utilize (i) entity terms 144 from, for example, the entity store 114 (e.g., business entities), (ii) brand terms 146 from the brand store 116, and/or (iii) product terms 147 from the product store 117. Terms from the various content filters 120 can be used to filter the targeted social media 113 for media items that are relevant to specific topics. More specifically, the content filter 120 implements, for example, key word or phrase filters, or other criteria, to determine items of the targeted social media 113 which (i) are deemed relevant to a particular topic, (ii) originate from a particular person, and/or (iii) reference a particular content item.

In addition, some social media can be tracked and analyzed based at least in part on the contents of the social media. In one embodiment, social media can be subjected to content filters for terms of topics. The presence of terms (subject to algorithmic determinations) can enable social media items to be correlated to a specific topic. References in items of social media to specific topics can be aggregated to determine, for example, trends in public interest or discourse for the specific topic.

The analysis component 110 can process the targeted social media 113 to determine metrics that score topics on the significance of the corresponding targeted social media 113. In this way, the targeted social media 113 can be used to determine the online significance (e.g., popularity, online discussion, trends, etc.) for topics identified by specific brands, products, and business entities. As such, the targeted social media 113 can serve as an early predictor as to issues that become more significant to the public discussion. For example, the targeted social media 113 can be used to determine when a product is trending in significance, despite lack of company announcements or news. Such discussion can signify, for example, a design flaw or issue with a product that is the topic of discussion and opinion amongst those that are most knowledgeable on the topic.

The presentation component 130 can display results of the analysis component 110 on social media 103, 113. In one implementation, metrics of the analysis component 110 can be used to present graphs or other output (e.g., subject content social data 132) that enables customers or other users of the service to view the results of the analysis component 110.

Methodology

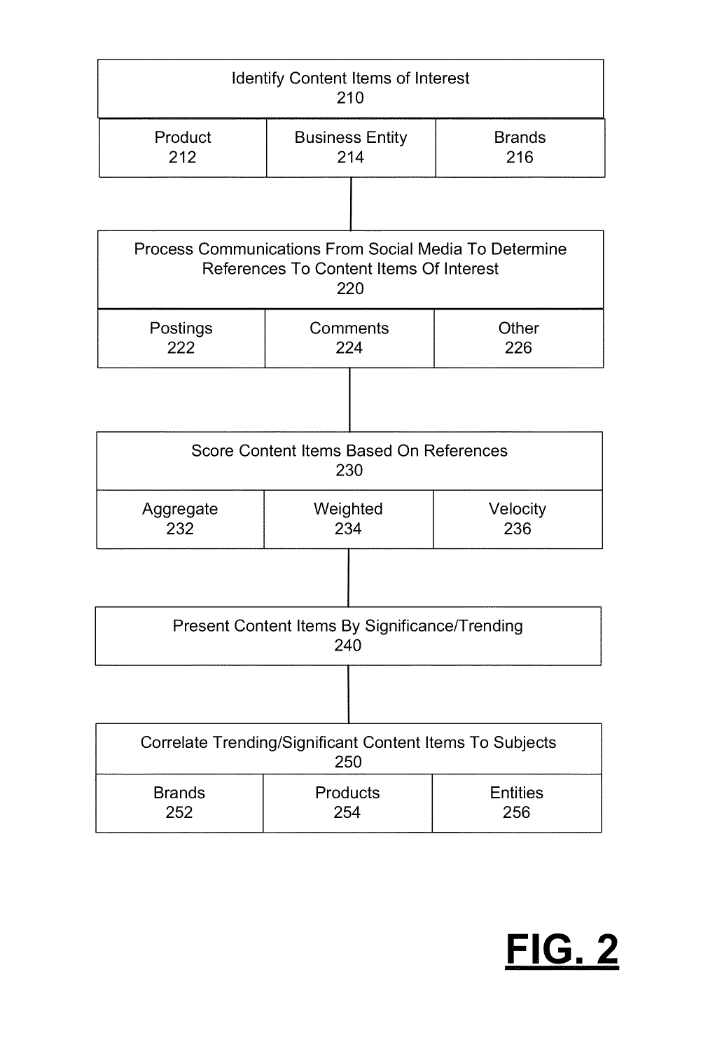

FIG. 2 illustrates a method for determining an online significance of a content item, according to one or more embodiments. A method such as described with an embodiment of FIG. 2 can be implemented using computing resources, such as provided through a server or combination of computers, in order to make programmatic determinations as to the contents of social media, as well as to how content items are being communicated or discussed through social media. Accordingly, programmatic components can be configured to access and scan social media from numerous sources in order to make real-time determinations as to the extent to which content items are discussed, viewed, or otherwise trending in public awareness. In some embodiments, a method such as described by FIG. 2 may be implemented using, for example, a system such as described with FIG. 1. Accordingly, reference may be made to elements or components of FIG. 1 for purpose of illustrating a suitable component for performing a step or sub-step being described.

According to an embodiment, content items of interest are identified (210). The identification of content items can be made on a periodic or repeated basis, using programmatic resources, such as web crawlers or interfaces for receiving online content publications. In some implementations, the source of the content items is targeted. For example, specific websites can be programmatically accessed for purpose of receiving RSS feeds, or to retrieve content. For some types of content items, replication or republication of the content item can also take place. For example, the same content item can be made available at multiple websites. Links to the location of the content items, as well as links to known or identified copies, can be determined and stored in the content library 112.

Still further, the content items of interest can be further refined based on, for example, topical designations, such as products (212), business entities (214) and brands (216). In such variations, content retrieval may be parsed or otherwise analyzed in order to determine whether topical designations (e.g., product class, specific product) can be assigned based on the content.

Social media can be accessed and processed in order to identify social media items that reference the individual content items of interest (220). In an embodiment, social media corresponding to posts (e.g., text entries and/or image submissions by persons to their respective social network accounts for communication to social network contacts or friends) are processed to identify links that reference one of the content items of interest (222). In variations, social media is processed for other kinds of identifiers of the content item. These can include the title or byline, author, summary, accompanying tags or metadata, image or other information.

Some variations also provide for use of social media in the form of comments that accompany content items (224). Thus, for example, the content items of interest can be periodically scanned for comments by viewers. The comments by viewers can be topiced to scoring or other analysis that provides indication of the online significance of the content item.

Other forms of social media can also be processed (226). For example, check-ins, status updates, feedback (e.g., “likes” or ratings) can be detected and processed, in connection with content items of interest.

As an alternative or variation, system 100 can include components that request social trending information from social media sources 90 for specific content items, such as those provided on a webpage or server. In some embodiments, for example, the request may be sent to the one or more social media servers using one or more third party application programming interfaces (APIs) to communicate with the one or more social media servers. For example, each social media service may include one or more APIs operative to allow third party services to access information from the social media service. These APIs may include any suitable interface and in some embodiments may comprise open source code.

The content items can be scored based on references to the content items in social media (230). The scoring can also be varied based on the type of social media (e.g., type of social media post, comments to post of another, feedback, etc.). The specific weights or formula used to score the content items can vary based on implementations. In some implementations, the scoring is multi-dimensional, so as to comprise multiple scores or scoring components.

In variations, a service may return an aggregated form of the social media trending information. For example, the social media trending information may include an aggregate number of links, comments, shares, or other social media identifiers associated with the content.

In some variations, an aggregate score is determined for the referencing of a content item in social media (232). The aggregate score can be based on a number of instances in which a content item is referenced or noted in social media. The reference contained within the contents of the social media to the content item can, for purpose of aggregation, be in the form of the contents of postings, comments to the postings, and/or feedback to the postings with the original reference.

As an addition or variations, some facets of scoring can be weighted (234). For example, in the context of a social media post that references a content item of interest and which includes comments and feedback (e.g., “likes”), the feedback can be weighted more significantly than comments, which are not necessarily relevant to the initiating post. Still further, weights can be determined based on factors such as the type of social media, the age of the social media item, the social networking platform where the social media was provided, or the authors or submitters of the social media items.

In some variations, a velocity score is determined that takes into account an aggregation score (e.g., weighted or otherwise) over a recent and discrete duration of time (236). In variations, the velocity score can also be based on a comparison of the aggregation scores for the content item (or similar content items) over a longer duration of time. In this way, the velocity score can provide a real-time snapshot as to what content items are significant at a moment, based on, for example, how that content item was previously scored, or how similar content items normally score. In this way, the velocity score enables a real-time determination of content items that are trending at a current and discrete instance in time.

In variations, the content items can be scored based on social media references to topical designations that are deemed relevant to the content items. For example, if one of the content items of interest is a news story about a specific product, then social media references to that specific product may influence the scoring of the content items.

As another example, the score can be a social metric score formula based on a ration of Aggregatehits/Divisor, where Aggregatehits is a variable that represents total number of actions taken by social network participants (e.g., summation of Diggs, Facebook Likes, Facebook shares, Facebook comments, Tweets, etc.), and the Divisor a time duration measured in, for example, seconds.

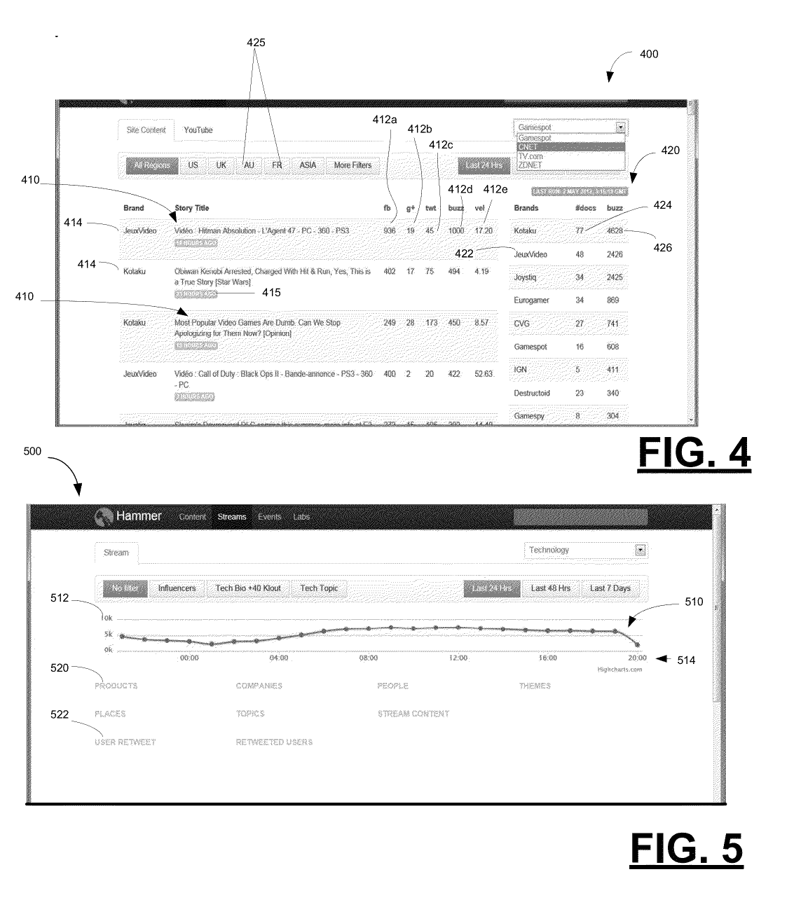

A presentation can be provided that shows the scoring of at least some of the content items of interest (240). The scoring can reflect the online significance, or trend (in viewership or interest) of the content item. The presentation can provide a near real-time reflection of the viewership or public interest. FIG. 4A and FIG. 4B provide examples of presentations, in accordance with one or more embodiments.

In some embodiments, the scoring for some content items of interest can be correlated to topics (250), such as brands (252), products (254) or business entities (256). For example, content items can be correlated to topical terms, and the scoring of the content items can then be correlated to the topical designations. In this way, the determination of the online significance of content items can be correlated to rends or interest in topics such as products, brands or companies.

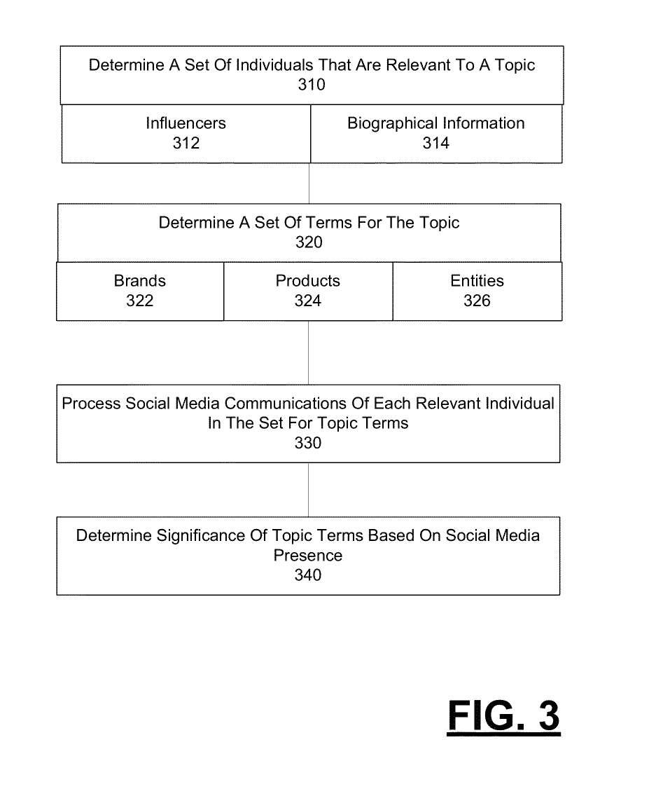

FIG. 3 illustrates a method for processing targeted social media to determine trends amongst topics and content items, according to one or more embodiments. A method such as described with an embodiment of FIG. 3 can be implemented using computing resources, such as provided through a server or combination of computers, in order to retrieve or identify targeted social media, and to determine the applicability of targeted social media to topics or content items. Accordingly, programmatic components can access and scan social media from numerous sources in order to make real-time identification of targeted social media, as well as determinations as to the relevance of items of targeted social media to topics and/or content items. In some embodiments, a method such as described by FIG. 3 may be implemented using, for example, a system such as described with FIG. 1. Accordingly, reference may be made to elements or components of FIG. 1 for purpose of illustrating a suitable component for performing a step or sub-step being described.

According to embodiments, a set of individuals (or entities) are determined that are relevant to a specific topic (310). The topic can be defined by an administrator. In some examples, the topic can reflect a product, product class (e.g., laptops or computers, television shows, entertainment), brand or business entity. The individuals can correspond to influencers (312), such as experts, publishers, or other individuals who are deemed to be highly influential for a specific topic. Such influencers can, for example, be manually identified. For example, for topics relating to gaming, the influencers may correspond to bloggers and/or journalists who specialize in gaming.

In addition to influences, one or more embodiments provide for programmatically identifying individuals relevant to a particular topic using biographical information that is made publicly available through social media (314). For example, in many social networking environments, users publish biographical information, listing hobbies, interests or expertise. The fields for such information can be inspected to identify individuals who have interest or expertise in a particular topic.

A library of terms can be identified for a specific topic (320). For example, in the context of topics relating to “technology” or “computing devices”, the library of terms can identify brands (322), products or product classes (324), or entities (326), such as manufacturers. In the context of gaming, the library of terms can call out titles, manufacturers, gaming platforms, etc.

Subsequently, social media of the identified relevant individuals is processed to determine social media items that reference or pertain to a topic term (330). In one embodiment, a collection of social media is filtered for authorship, comments or feedback that relate to individuals that are deemed relevant to the topic. In variations, social media is targeted to particular sources based on their identification as being a person of relevance to a topic. For example, feeds from specific users of a social networking platform can be targeted in order to obtain their social media communications.

In one embodiment, the social media that is filtered or targeted from the various persons (e.g., sources) is topiced to one or more content filters which serve to identify when the items of social media pertain to a particular term in the set of topic terms. Thus, for example, social media can be filtered for topic terms that identify brands, products or manufacturers.

As an addition or variation, the social media from the relevant individuals can also be filtered for identifiers to content items pertaining to the topic, such as articles or reviews for a particular game or product. The identifiers can correspond to, for example, a link to an article, or a title of an article.

In some embodiments, the significance of topic terms are determined based on social media presence (340). The analysis component 110, for example, may aggregate references to specific products or brands from social media of relevant individuals. For example, social media from the relevant persons can be filtered for topical terms, with results of the filtering process being aggregated or used to determine scores or metrics for the social media. These references can be weighted based on, for example, the information known about the social media poster, the recency of the social media, the platform or type of social media, etc. The determination of significance for the topic terms can be made for a particular duration in time, such as a particular day. As such, the determination may be deemed to be real-time.

### PRESENTATION EXAMPLES

FIG. 4 illustrates an example presentation 400 for displaying scores and information regarding the online significance of content items, according to one or more examples. In an embodiment, presentation 400 includes a listing of content items 410, which in the example provided, correspond to online articles, such as news stories or blog entries. Other kinds of content items include media clips, such as video clips provided through platforms that enable sharing and/or commentary (e.g., sharing video clips on FACEBOOK or YOUTUBE). According to some embodiments, the content items 410 can be correlated to a specific topic, such as a brand 414, product, or product class. For example, the content items 410 can be determined to originate from a particular source, such as a content feed or website sponsored with the brand. As an alternative or addition, the content items 410 can be analyzed for text content and/or metadata (e.g., tags) in order to determine the topic of the content item, including, for example, relevant brands or products. Each content can include a time element 415 that indicates when the content item was first published.

In the example of FIG. 4, each content item 410 includes multiple scores 412 that indicate the interest in the article amongst users of various social media service. For example, a first score 412a indicates a metric for the amount of interest shown to each of the depicted content items amongst a social network such as FACEBOOK. Other scores 412b, 412c can be provided for other social networking environments (e.g., such as GOOGLE PLUS or TWITTER). An aggregate score 412d can also be provided, representing an aggregation of scores (weighted or non-weighted) from multiple social media services. A velocity score 412e can represent a count (aggregate, weighted, etc.) of the number of references to the content items (e.g., postings, re-postings, comments, feedback, etc.) over a recent (or current) discrete interval of time.

In an example shown by FIG. 4, one or more geographic filters 425 can be employed to filter social media items from specific regions, such as countries. In some variations, social media from specific regions can also be referenced against terms that are specific to the corresponding region.

In an embodiment, a list 420 can be generated based on topical identifiers 422, such as brands, identifying (i) a number 424 of content items that are deemed relevant to the topical identifier, and (ii) a score 426 that indicates the social media references or activity for the content items of the individual topical identifiers. The list 420 can utilize correlations between content items and topical identifiers in order to determine a “buzz” pertaining to the particular topical identifier. The “buzz” can represent, for example, the viewership or awareness of content items pertaining to the particular topical identifier. For example, the release of a new product can generate several news articles that discuss the particular product. The references to the various articles in social media provides a basis for determining the “buzz” for the particular product or product brand.

FIG. 5 illustrates an example presentation 500 for graphically displaying scores and other information determined from the social media of targeted sources. In an embodiment, presentation 500 corresponds to a graph 510 that maps a quantity of social media from a designated set of users that are deemed relevant to a particular topic category or genus (e.g., “technology”). Thus, for example, with reference to FIG. 1, the graph 510 can reflect social media that has been subjected to the source filter 124.

The graph 510 is an example of an aggregation presentation. Other forms of aggregation presentations can be used to reflect, for example, a quantity of social media relevant by source (e.g., person), topic, sub-topic and/or type of social media.

As an addition or alternative, the graph 510 may map a quantity of social media 512 that pertains to or references terms associated with a particular topic over a period of time 514 (e.g., over the course of a day). For example, a term set may be defined for “Technology” and social media that is deemed to be about such terms can be counted or scored.

According to an embodiment, the presentation 500 can be filtered by sub-topics 520. In the example provided, the sub-topics 520 can correspond to, for example, products, companies or people. Each sub-topic is associated with a set of persons who are influencers, or otherwise relevant to the topic. As an alternative or variation, each sub-topic is associated with a set of terms, for use in analyzing social media to determine whether items of social media pertain to a particular sub-topic.

As another addition or variation, the sub-topics can identify types of social media 522 that are to be counted in a particular aggregation display. For example, social media of a particular type (e.g., retweets) can be aggregated for a particular topic or sub-topic, providing another metric of significance for the topic. The retweets, for example, can also be aggregated for sources (e.g., persons who retreat).

In the examples of presentations provided by FIG. 4 and FIG. 5, the presentations 400, 500 can be provided through, for example, system 100, as described with FIG. 1. For example, the presentations 400, 500 can be generated as output from the presentation component 130 of system 100. In one implementation, each of the presentations 400, 500 can be provided through, for example, a browser that accesses a website of system 100, or through a web-based application that receives content from a network site. For example, customers (e.g., advertisers, online publishers) can subscribe or register with a service of system 100 to receive near real-time updates as to content items that are of the most interest in a particular topic (e.g., technology).

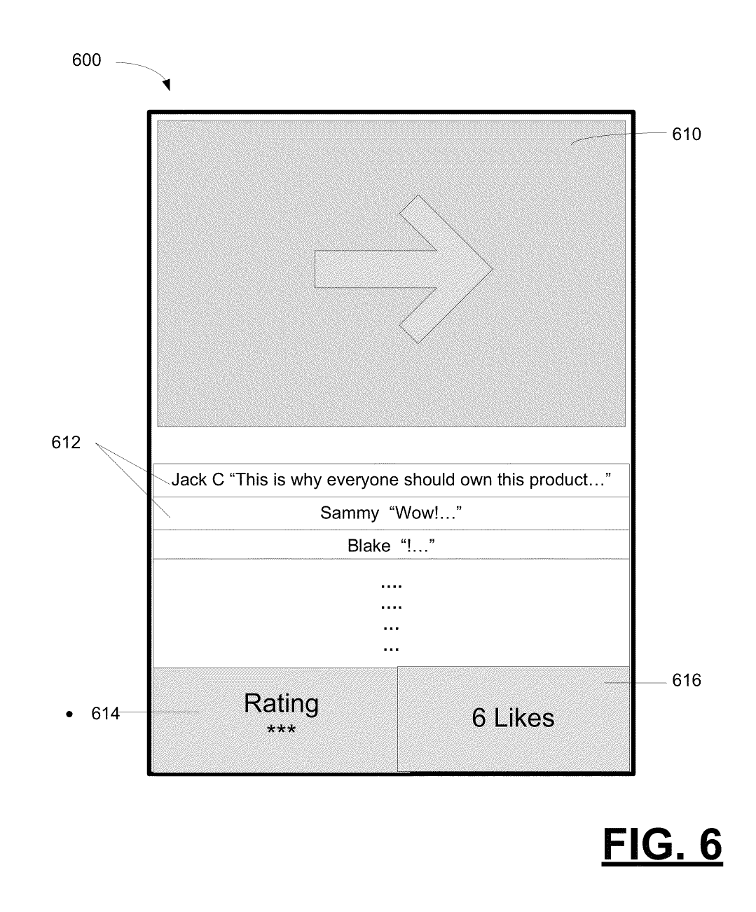

FIG. 6 illustrates another embodiment in which social media is collected from comments submitted in connection with another content item, according to one or more embodiments. A content item 610 of presentation 600 can correspond to, for example, a video clip, article, or image. In some implementations, the type of social media used to determine trends in content items can vary based on the type of media. For example, social media for video clips can be in based on the number of comments that the clip received at social networking sources, as well as video publication sources which allow comments. The content item can be published at a publisher site, separate from social network sites. The publisher can enable the content item 610 to receive comments 612 and feedback from persons. In particular, the feedback can include ratings 614 or “likes” 616.

In some embodiments, the comments 612 provided with the content item 610 serve as a social media feed. For example, with reference to an example of FIG. 1, social content retrieval 102 can be configured to scan the publisher site for content items 610 and their respective comments 612 and feedback. In one implementation, comments and feedback can be subjected to, for example, content filter(s) 120, which can scan for references to terms such as identified by the entity store 114, brand store 116 or product store 117. References to such terms can be tabulated and used to determine, for example, the significance of the content item 610, or of the terms referenced in the comments and feedback. In variations, the comments 612 and feedback can be used to determine the significance of the content item 610 itself. For example, the number of comments that the content item 610 receives can tracked, in a manner such as described with an example of FIG. 4.

Numerous variations are possible, including scanning the comments and feedback for comments from persons who are identified in the social content publisher 118 list. Thus, for example, the comments and feedback can be subjected to source filter 124, and the accumulation of such references can be tabulated such as in a manner described with an example of FIG. 5.

Alternatives and Variations

As an alternative to social media services, trending information from social media can include information or referrals generated from web based email clients, such as Hotmail® or Gmail®, for example. The information referrals may comprise, in various embodiments, links to content contained within emails sent using the above-referenced services, or any other type of suitable referral or link.

As another alternative or variation, social media scores can be used to connect brands, products or entities to one another. For example, if social media references two products equally amongst a common population of users, an inference can be made that the two products are connected as being similar products, or products that are connected to one another in social media. For example, U.S. patent application Ser. No. 13/153,376, which is hereby incorporated by reference, describes computer-implemented techniques for arranging assets in a structured ontology thus may provide detailed information about the connections between assets.

Using Sentiment Analysis with Social Media Trend Analysis

In some embodiments, social media can also be analyzed for sentiment (e.g., “good”, “bad” or “neutral”). The sentiment values of the social media items (e.g., postings) can be used to, for example, weight how items are deemed to be trending. For example, content items, products, brands, etc. that are referenced in social media with high sentiment scores can also have their trend scores weighted to reflect greater popularity, as compared to content items, products, brands etc. that are referenced with low sentiment scores. U.S. patent application Ser. No. 13/098,302, which is hereby incorporated by reference, describes computer-implemented uses for determining sentiment from content, as well as the application of sentiment analysis. U.S. patent application Ser. No. 13/433,168, which is also hereby incorporated by reference, describes computer-implemented uses for determining sentiment from content, as well as the application of sentiment analysis to commercially relevant statements made in context such as with social networking sites.

As an alternative to weighting, for example, sentiment analysis can also be used as a criteria to sort content item or other subjects of trend analysis. For example, a most popular category of content items can reflect those content items that are referenced in social media and which return positive sentiment, while a least popular category of content items can reflect those content items that are referenced in social media and which have negative sentiment.

Still further, some embodiments provide for utilizing sentiment as expressed in social media. For example, sentiment values can be determined for individual items of social media. The sentiment values can reflect a “positive” or “negative” sentiment for a subject of a content item (e.g., Facebook post). A sentiment analysis technique can be implemented in which (i) subjects are identified for a particular domain (e.g., for a product or brand); (ii) a word list is predetermined for the domain, where the word list includes terms and expressions that are typically used to convey sentiment in the particular topic or generated category of the subjects; (iii) a predetermined sentiment score can be associated with each entry of the word list; (iv) text content is parsed and analyzed for sentiment scores in accordance with a set of rules and/or algorithm. By way of example, clausal analysis may be used to indentify sentences and clauses in a user's text content. The identification of sentences/clauses provides a mechanism to determine what expressions of user sentiment relate to, for example a particular brand.

In addition to clausal analysis, certain rules may be implemented to determine the relevance or significance of certain terms. For example, a grammatical rule may correspond to one word sentences that use terms of strong sentiment, such as “Fantastic!”. The presence of such sentences may be predetermined by rule for specific treatment as to relevance and context.

In addition to grammatical analysis, proximity of a sentiment term to the subject (or its category) may also reflect the user's sentiment for the subject (e.g., brand or product content item).

A subject-sentiment scoring algorithm is implemented to determine one or more sentiment values that characterize the user sentiment for the subject, or relevant domain specific categories pertaining to the subject. Specifically, various sentiment values are determined at the level of the domain category, by article and/or by author.

A determined sentiment value may reflect the user's overall sentiment, or the user's sentiment for a particular aspect of the subject. A sentiment valuation algorithm, for example, may utilize various parameters and metrics in determining the sentiment value for the subject or subject's domain category. Individual terms of sentiment may, for the given domain, be associated with a sentiment score that can reflect like/dislike and/or other sentiments. A valuation algorithm may, for example, use summation, weights or other formulations in order to determine the score of the user's sentiment for the subject or the domain category of the subject.

Another parameter for determining sentiment includes word pairing. For example, in social media, the sentiment carried by some terms may better be understood and quantified using word pairing. Word pairings correspond to two or more words that appear together, in the same sentence or sufficiently proximate to one another to assume they can be paired. Requirements may be stored as for spacing terms, depending on the particular word and/or domain. Embodiments recognize that social media can use abbreviated sentences, or phrases that lack proper sentence structure. Accordingly, word pairings can be deemed to carry additional weight as to a particular sentiment (e.g., good, bad or neutral). The presence of word pairings in social media can be used as a marker in the analysis of determining the sentiment of the social media for the subject (e.g., brand).

Still further, the word pairing may verify sentiment value for a particular sentiment, rather than separately scored a sentiment. In variations, word pairing can also be used to determine relevancy of a term of sentiment.

In use, social media items can be analyzed to determine a sentiment score for the social media item as a whole, based on, for example, sentiment values of individual terms contained in the item of social media. For example, the sentiment score for the social media items can be averaged, weighted or otherwise tallied in determining the sentiment value associated with the subject (or subject category)

Computer System

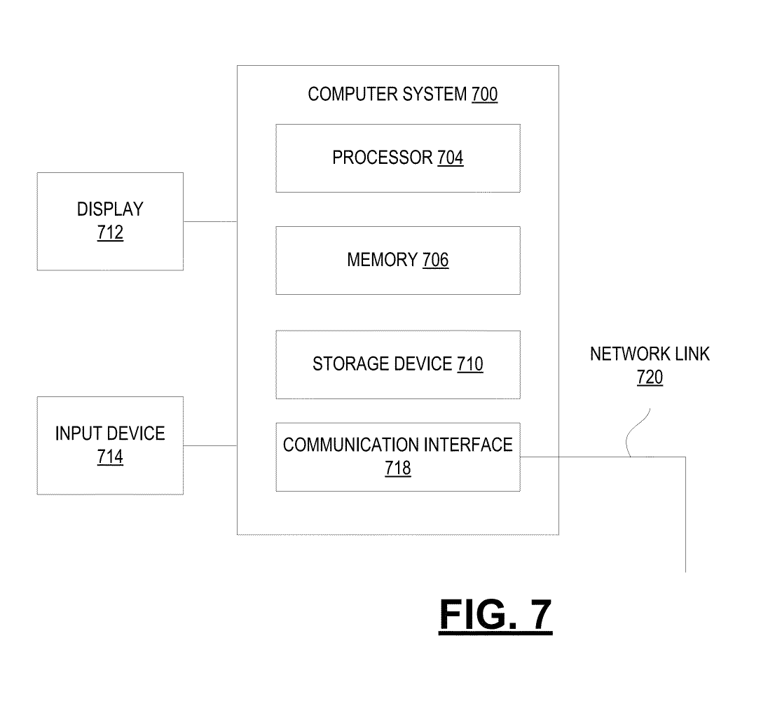

FIG. 7 is a block diagram that illustrates a computer system upon which embodiments described herein may be implemented. For example, in the context of FIG. 1, system 100 may be implemented using one or more computer systems such as described by FIG. 7.

In an embodiment, computer system 700 includes processor 704, memory 706 (including non-transitory memory), storage device 710, and communication interface 718. Computer system 700 includes at least one processor 704 for processing information. Computer system 700 also includes a main memory 706, such as a random access memory (RAM) or other dynamic storage device, for storing information and instructions to be executed by processor 704. Main memory 706 also may be used for storing temporary variables or other intermediate information during execution of instructions to be executed by processor 704. Computer system 700 may also include a read only memory (ROM) or other static storage device for storing static information and instructions for processor 704. A storage device 710, such as a magnetic disk or optical disk, is provided for storing information and instructions. The communication interface 718 may enable the computer system 700 to communicate with one or more networks through use of the network link 720 (wireless or wireline).

Computer system 700 can include display 712, such as a cathode ray tube (CRT), a LCD monitor, and a television set, for displaying information to a user. An input device 714, including alphanumeric and other keys, is coupled to computer system 700 for communicating information and command selections to processor 704. Other non-limiting, illustrative examples of input device 714 include a mouse, a trackball, or cursor direction keys for communicating direction information and command selections to processor 704 and for controlling cursor movement on display 712. While only one input device 714 is depicted in FIG. 7, embodiments may include any number of input devices 714 coupled to computer system 700.

Embodiments described herein are related to the use of computer system 700 for implementing the techniques described herein. According to one embodiment, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for determining significance of content items, the method being implemented by one or more processors and comprising:
(a) identifying a set of content items, each content item in the set being relevant to a topic;
(b) processing items of social media, provided with a plurality of social media services, in order to identify individual items of social media that reference one or more content items in the set;
(c) determining a score of each of the one or more content items, the score of each of the one or more content items being based at least in part on a number of instances in which that content item is referenced by the items of social media; and
(d) providing a presentation that identifies a plurality of content items, and the score for each of the plurality of content items.

2. The method of claim 1, further comprising determining that one or more topics are trending in interest amongst a population, based at least in part on the score of each of the one or more content items.

3. The method of claim 2, wherein the one or more topics correspond to a brand, a product identifier, or a business entity.

4. The method of claim 1, wherein (c) is based on the number of times that the one or more content items are referenced in the processed items of social media over a recent and defined duration of time.

5. The method of claim 1, wherein (b) includes processing items of social media provided with the plurality of social media services substantially in real-time.

6. The method of claim 1, wherein the one or more content items correspond to a news link.

7. The method of claim 1, wherein the one or more content items correspond to a video clip.

8. The method of claim 1, wherein (b) includes identifying user comments that are submitted to a particular content item.

9. The method of claim 8, wherein (c) includes incorporating the number of comments that are submitted for each of the one or more content items.

10. The method of claim 1, wherein (b) includes determining a number of times an item social media referencing the one or more content items is commented on or liked, and wherein (c) includes incorporating, as part of the score, the number of times that the communication is commented on or liked.

11. The method of claim 1, wherein (c) includes determining a velocity score that is based on the number of instances in which that content item is referenced by the items of social media over a specified duration of time.

12. A method for determining trends, the method being implemented by one or more processors and comprising:
determining (i) a set of individuals who are relevant to a particular topic, and (ii) a set of terms for the particular topic;
identifying items of social media that originate from each individual in the set of individuals in one or more social media services;
determining, from the identified items of social media, a quantity of items of social media that are relevant to one or more terms in the set of terms; and
determining, based at least in part on the quantity, that the one or more terms in the set of terms are of significance amongst the set of individuals.

13. The method of claim 12, wherein determining the set of individuals includes processing published biographical information from individuals on the one or more social media outlets.

14. The method of claim 12, wherein the set of terms include a list of one or more of a brand, a product identifier or a business entity.

15. The method of claim 12, further comprising providing a graphical presentation of the quantity of the items of social media for the one or more terms.

16. The method of claim 15, wherein the quantity of the items of social media include items of social media from different social media services.

17. The method of claim 12, wherein determining that the one or more terms in the set of terms are of significance includes determining that the one or more terms in the set of terms are trending in use amongst one or more social media services.

18. A non-transitory computer-readable medium for determining significance of content items, the computer-readable medium storing instructions, that when executed by one or more processors, cause the one or more processors to perform operations comprising:
(a) identifying a set of content items, each content item in the set being relevant to a topic;
(b) processing items of social media, provided with a plurality of social media services, in order to identify individual items of social media that reference one or more content items in the set;
(c) determining a score of each of the one or more content items, the score of each of the one or more content items being based at least in part on a number of instances in which that content item is referenced by the items of social media; and
(d) providing a presentation that identifies a plurality of content items, and the score for each of the plurality of content items.

19. The computer readable medium of claim 18, further comprising instructions for determining that one or more topics are trending in interest amongst a population, based at least in part on the score of each of the one or more content items.

20. The computer readable medium of claim 19, wherein the one or more topics correspond to a brand, a product identifier, or an entity.
